(19) United States
(12) Patent Application Publication
(10) Pub. No.: US 2026/0236699 A1
(43) Pub. Date: Aug. 13, 2026

(54) Systems and Methods for Interactive Geometric Interfaces for Persistent Cognitive Manifolds

(71) Applicant: AtomBeam Technologies Inc., Moraga, CA (US)

(72) Inventor: Brian Galvin, Silverdale, WA (US)

(21) Appl. No.: 19/560,459

(22) Filed: Mar. 9, 2026

Related U.S. Application Data
(63) Continuation-in-part of application No. 19/397,858, filed on Nov. 21, 2025.
Application No. 19/397,858 is a continuation-in-part of application No. 19/328,094, filed on Sep. 12, 2025, now Pat. No. 12,632,663.
Application No. 19/328,094 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/900,388, filed on Oct. 16, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method enables interactive human engagement with persistent cognitive manifolds maintained by a computational system. An interactive geometric interface exposes structured internal cognitive representations as objects of governed interaction, permitting users to inhabit, traverse, and selectively modify the cognitive manifold through geometric navigation and editing operations. A control layer enforces accessibility policies determining which regions of the manifold are computationally reachable at a given time. An operational mode manager selects among exploration, assisted editing, and direct editing modes, with governance constraints, preview mechanisms, and irreversible commitment protocols varying across modes. A supervisory control layer monitors manifold evolution, enforces system-level constraints, and may intervene to restrict or downgrade active modes upon detection of instability. Rate control mechanisms limit the frequency and magnitude of user-directed modifications. All interaction and modification events are recorded by an auditability infrastructure to support transparency and long-horizon operation.

### CROSS-REFERENCE TO RELATED APPLICATIONS

Priority is claimed in the application data sheet to the following patents or patent applications, each of which is expressly incorporated herein by reference in its entirety:
Ser. No. 19/397,858
Ser. No. 19/328,094
63/900,388
Ser. No. 19/321,173
Ser. No. 19/284,115
Ser. No. 19/051,193
63/847,082
63/847,091
63/847,096
63/847,101

### BACKGROUND OF THE INVENTION

### Field of the Invention

The present invention relates to the field of machine learning and artificial intelligence, particularly to systems for memory-augmented reasoning and long-term cognitive processing.

### Discussion of the State of the Art

Recent advances in artificial intelligence have achieved remarkable progress in processing and generating human-like responses across various domains. Large language models demonstrate sophisticated pattern recognition and generation capabilities, while computer vision systems approach human-level performance in object recognition and scene understanding. However, these systems fundamentally lack the ability to capture, represent, and reason about human experiences in their full phenomenological richness.

Current AI architectures process information through static embeddings and fixed neural network weights, treating each input as an isolated computational event. While techniques like retrieval-augmented generation and vector databases provide some form of memory, they operate as external lookup mechanisms rather than integrated experiential understanding. These systems cannot genuinely comprehend the emotional texture, temporal flow, or contextual nuance that characterizes human experience.

Existing approaches to emotion recognition typically reduce complex affective states to discrete categorical labels or simple dimensional values. Similarly, multimodal fusion techniques combine sensory inputs through concatenation or attention mechanisms but fail to preserve the synesthetic relationships and holistic nature of experiential moments. Memory systems in current AI are fundamentally transactional—storing and retrieving information without the ability to form meaningful connections, discover resonances across experiences, or synthesize wisdom from accumulated life events.

The computational representation of human experience poses unique challenges that current architectures cannot address. Experiences are not merely collections of sensory data but involve complex interactions between perception, emotion, memory, and meaning that unfold dynamically over time. Current systems lack mechanisms for representing the continuity of consciousness, the narrative structure of memory, or the emergent insights that arise from reflection on past experiences.

Furthermore, existing AI systems process each user interaction independently, unable to build genuine understanding of an individual's experiential history or extract meaningful patterns from their life journey. Privacy-preserving techniques in current systems focus on data protection but cannot enable the nuanced sharing of experiential understanding while maintaining personal boundaries. Collaborative intelligence remains limited to parameter averaging or ensemble methods rather than true experiential synthesis.

What is needed is a system and method that can represent human experiences as living geometric structures within an evolving manifold, discover meaningful resonances between experiences across multiple dimensions, synthesize wisdom from experiential patterns while preserving their phenomenological qualities, enable privacy-preserving sharing and collaborative weaving of experiences, and support applications in personal growth, therapy, education, and collective intelligence. Such a system should treat experiences not as data to be processed but as geometric entities with intrinsic structure, relationships, and evolutionary potential.

### SUMMARY OF THE INVENTION

The inventor has developed a system and method which enables interactive human engagement with persistent cognitive manifolds maintained by a computational system. An interactive geometric interface exposes structured internal cognitive representations as objects of governed interaction, permitting users to inhabit, traverse, and selectively modify the cognitive manifold through geometric navigation and editing operations. A control layer enforces accessibility policies determining which regions of the manifold are computationally reachable at a given time. An operational mode manager selects among exploration, assisted editing, and direct editing modes, with governance constraints, preview mechanisms, and irreversible commitment protocols varying across modes. A supervisory control layer monitors manifold evolution, enforces system-level constraints, and may intervene to restrict or downgrade active modes upon detection of instability. Rate control mechanisms limit the frequency and magnitude of user-directed modifications. All interaction and modification events are recorded by an auditability infrastructure to support transparency and long-horizon operation.

According to a preferred embodiment, a computing system for interactive engagement with a persistent cognitive manifold, comprising: a processor; and a memory storing instructions that, when executed by the processor, cause the computing system to: maintain structured internal cognitive representations persistently across a plurality of user interactions; receive user input corresponding to geometric interaction operations and interpret the user input as a request to traverse, inspect, or modify the structured internal representations; enforce one or more accessibility policies governing which portions of the structured internal representations are computationally reachable by a requesting user during a given processing cycle; select among a plurality of operational modes governing the manner in which user-directed modifications to the structured internal representations are mediated, validated, and committed; and execute committed modifications irreversibly, such that prior states of affected representations are not restored following commitment.

According to another preferred embodiment, a computer-implemented method for interactive engagement with a persistent cognitive manifold, the method comprising the steps of: maintaining structured internal cognitive representations persistently across a plurality of user interactions; receiving user input corresponding to geometric interaction operations and interpreting the user input as a request to traverse, inspect, or modify the structured internal representations; enforcing one or more accessibility policies governing which portions of the structured internal representations are computationally reachable by a requesting user during a given processing cycle; selecting among a plurality of operational modes governing the manner in which user-directed modifications to the structured internal representations are mediated, validated, and committed; and executing committed modifications irreversibly, such that prior states of affected representations are not restored following commitment.

According to a further aspect, the method includes enforcing the one or more accessibility policies by distinguishing between representations that are stored within the system and representations that are operationally reachable or modifiable at a given time.

According to a further aspect, the method includes selecting among the plurality of operational modes comprises defaulting to an exploration mode in which modification of persistent internal state is disabled, and transitioning to a mode permitting modifications in response to explicit user intent and satisfaction of applicable permission criteria.

According to a further aspect, the method includes generating a preview of a proposed modification through non-destructive simulation prior to commitment, and requiring user confirmation before executing the modification.

According to a further aspect, the method includes executing committed modifications irreversibly comprises advancing a notion of structural time within the system upon each commitment, such that the system accumulates an ordered history of prior modification events without restoring accessibility to superseded representations.

According to a further aspect, the method includes enforcing rate control over user-directed modifications, limiting at least one of the frequency of committed modifications, the magnitude of structural change permitted within a given interval, and the number of representations affected by a single operation.

According to a further aspect, the method includes monitoring evolution of the structured internal representations over time and, upon detecting conditions indicative of instability or policy violation, restricting the active operational mode to a less privileged interaction paradigm.

According to a further aspect, the method includes generating and maintaining audit records associated with interaction and modification events, wherein the audit records comprise at least identifiers of affected representations, temporal markers, and user identifiers.

According to a further aspect, the method includes supporting a plurality of users interacting with overlapping or partially shared structured internal representations, and enforcing user-specific accessibility and modification permissions across the shared representations.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram illustrating an exemplary system architecture for an interactive geometric interface system configured to enable user engagement with persistent cognitive manifolds, according to an embodiment.

FIG. 2 is a block diagram illustrating an exemplary detailed architecture of an interactive geometric interface, according to an embodiment.

FIG. 3 is a flow diagram illustrating an exemplary method for user traversal and manifold navigation, according to an embodiment.

FIG. 4 is a flow diagram illustrating an exemplary method for controlled accessibility and permission evaluation, according to an embodiment.

FIG. 5 is a flow diagram illustrating an exemplary method for edit proposal, preview, and irreversible commitment, according to an embodiment.

FIG. 6 is a flow diagram illustrating an exemplary method for implementing operational mode selection and transition within the interactive geometric interface system, according to an embodiment.

FIG. 7 illustrates an exemplary computing environment on which an embodiment described herein may be implemented.

### DETAILED DESCRIPTION OF THE INVENTION

The inventor has conceived, and reduced to practice, an experiential intelligence system transforms human experiences into computational insights through geometric representation and processing. The system employs an experiential geometric manifold that represents experiences as geometric structures in a multi-dimensional space encompassing emotional valence, sensory modalities, temporal evolution, and contextual embedding. An experience capture engine receives multimodal experiential data and transforms it into geometric representations suitable for integration into the manifold. An experiential resonance engine analyzes geometric relationships between stored experiences, identifying meaningful connections based on geometric proximity, curvature similarity, and topological features. A wisdom synthesis engine processes experience collections through geometric integration techniques to generate wisdom artifacts representing insights derived from patterns across multiple experiential trajectories. The system enables applications including personal growth, therapeutic support, educational platforms, and collaborative sense-making while maintaining privacy through geometric-level encryption and access control.

As an exemplary use case, consider a scenario where a combat veteran utilizes the experiential intelligence platform for post-traumatic stress disorder (PTSD) treatment. Sarah, a combat veteran who served in Afghanistan, begins using the geometric experiential intelligence system to address her post-traumatic stress disorder. She wears comfortable biosensor devices that monitor her physiological responses while she shares her experiences during an initial assessment session. As she speaks, the system constructs her personal experiential landscape, identifying several areas of intense emotional distress related to her combat experiences-a nighttime convoy ambush, the loss of a squad member, and an incident involving civilian casualties. The system maps these trauma regions as areas of high emotional turbulence within her experiential space, while also identifying surrounding trigger zones where related sensory experiences like loud noises or darkness might lead her toward these difficult memories.

Before beginning the therapeutic journey, the system establishes safety parameters based on Sarah's individual physiological patterns and emotional tolerance. It configures automatic grounding protocols that will activate if she becomes too distressed, including guided breathing exercises, muscle relaxation techniques, and the option to redirect her attention to previously identified positive memories. The system discovers several strong positive experiences in Sarah's life—her daughter's birth and her graduation from boot camp—that can serve as emotional anchors during difficult moments.

The therapeutic process begins gently, with the system guiding Sarah through experiences in the safer regions of her emotional landscape. During the first two weeks, she builds resilience by exploring positive memories and identifying resources that can support her healing journey. The navigation algorithm then computes a gradual approach path toward her trauma memories, maintaining a safe distance while slowly decreasing her avoidance patterns. She begins by exploring daytime driving experiences, then listening to engine sounds in controlled settings, viewing desert landscapes in daylight, and eventually discussing military vehicles with decreasing emotional activation.

Throughout this process, the system continuously monitors Sarah's responses. When she experiences distress while discussing military vehicles, the system immediately initiates grounding techniques. Gentle haptic feedback guides her breathing into a calming rhythm, while visual displays show her current emotional position relative to her safety anchors. Soothing audio cues help activate her body's natural relaxation response, allowing her to regain stability before continuing.

As Sarah progresses in her therapy, the system's resonance detection capabilities reveal an unexpected connection between her convoy ambush trauma and a childhood memory of being lost at night. This insight provides a therapeutic breakthrough—her combat experience had amplified pre-existing fears of darkness and abandonment from her youth. The system uses this discovery to create a therapeutic bridge, first helping Sarah process and integrate the less intense childhood fear using her adult resources and coping skills. The healing patterns she develops while addressing the childhood memory then serve as a template for approaching the more intense combat trauma.

During one session, Sarah accidentally encounters a news report about Afghanistan that triggers an intense emotional response related to her lost squad member. The system immediately responds by activating emergency stabilization protocols, switching her visual display to calming nature scenes while guiding her through specialized breathing exercises. It quickly calculates an escape route through positive memories, leading her to the anchor point of her daughter's birth memory. After she stabilizes, the system adapts her therapeutic plan, marking this unexpected trigger for careful future processing and adjusting the approach strategy for subsequent sessions.

Over the course of twenty sessions, the wisdom extraction component identifies several important patterns in Sarah's healing journey. The system recognizes that her combat-trained heightened awareness, rather than being purely symptomatic, can be reframed as a strength that serves protective purposes in appropriate contexts. It also discovers that experiences where Sarah helps others consistently reduce her trauma activation, leading to the insight that service-oriented action transforms survivor guilt into survivor purpose. Additionally, the system notices that when Sarah holds awareness of positive future experiences while processing trauma memories, her distress significantly decreases, establishing a new therapeutic technique.

After completing her initial treatment protocol, Sarah experiences substantial improvements. The emotional intensity of her trauma memories has significantly reduced, and the radius of her trigger zones has decreased by more than half. Her sleep quality improves, hypervigilance episodes reduce from daily to weekly occurrences, and she shows increased capacity for social engagement. The system generates a comprehensive view of her transformed experiential landscape, showing integrated trauma memories with reduced emotional charge, new clusters of positive post-trauma growth experiences, and strengthened connections between her resources and previously isolated traumatic memories.

The system continues supporting Sarah's recovery by providing daily emotional weather predictions based on patterns in her experiential landscape, early warnings for potentially triggering anniversaries, and suggested practices to maintain her therapeutic gains. Through privacy-preserving features, she can also connect with peer support networks, sharing certain aspects of her healing journey while maintaining complete control over her personal information. This ongoing support ensures that the progress Sarah has made remains stable and continues to strengthen over time.

This example demonstrates how geometric experiential intelligence transforms traditional trauma therapy by providing precise navigation through emotional landscapes, continuous safety monitoring, insight discovery through pattern recognition, and wisdom extraction from experiential healing. Sarah's journey illustrates how the system enables therapeutic interventions that adapt in real-time to individual needs while maintaining rigorous safety standards throughout the healing process.

The Cognitive Dynamics Engine (CDE), a specialized component that manages the complex geometric operations underlying cognition. The CDE orchestrates how attention flows through the manifold by calculating optimal paths that minimize cognitive effort while maximizing goal achievement, similar to how water finds the most efficient route down a hillside. It monitors and adjusts compression pressure throughout the space—regions where many concepts converge become harder to navigate, requiring more cognitive effort to traverse, while sparse areas allow for free exploration. The engine also maintains goal-driven potential fields that act like gravitational wells, drawing attention toward relevant areas of knowledge. As the system processes information, it naturally forms thought bundles—tightly integrated collections of related concepts that function as cognitive building blocks. These bundles can merge when similarities are discovered, expand when new connections are made, or recombine to form novel abstractions. During periods of inactivity, a specialized dream manager works with the CDE to reorganize the cognitive landscape, testing the stability of existing structures, discovering hidden connections between disparate concepts, and optimizing the overall geometry for more efficient future processing.

This geometric approach to intelligence yields properties that address fundamental limitations of current AI systems. The PCM implements a form of organic memory where information naturally persists or fades based on usage patterns—frequently accessed concepts maintain high activation energy and remain readily available, while unused information gradually dissipates through thermodynamic decay. This creates an intelligent forgetting mechanism that prevents cognitive clutter while preserving essential knowledge. The architecture scales efficiently, with memory requirements growing logarithmically rather than linearly as the system accumulates experience, because new information tends to reinforce and refine existing structures rather than requiring entirely new storage. The system supports sophisticated cognitive capabilities including hierarchical reasoning across multiple levels of abstraction, seamless integration of diverse sensory inputs into unified understanding, and distributed intelligence where multiple PCM instances can share abstracted knowledge while maintaining privacy. Applications range from technological forecasting through analysis of innovation trajectories to real-time anomaly detection in complex systems, from adaptive video compression that understands content semantically to persistent AI assistants that truly learn and evolve through interaction. By reconceptualizing intelligence as the evolution of geometric structure rather than the accumulation of parameters, the PCM opens new possibilities for creating AI systems that learn continuously, reason coherently, and develop genuine understanding through the physical shape of their thoughts.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “thought” refers to a discrete unit of reasoning or analysis generated by a large language model or multimodal inference engine during its processing of an input prompt. A thought represents the model's intermediate reasoning steps, contextual interpretation, or internal deliberation that contributes to a final output. Thoughts may be atomic (e.g., a factual claim), structured (e.g., an inference chain), or multimodal (e.g., a fused representation of text and video). Unlike raw tokens or embeddings, thoughts encapsulate processed cognition and are suitable for caching, recombination, and reuse across future interactions. Thoughts may be stored explicitly or synthesized during recall and may evolve through compression or generalization.

As used herein, “thought cache” refers to a structured memory layer configured to store and retrieve thoughts based on semantic similarity, contextual alignment, or system policy. The cache may include multiple tiers, such as session caches for short-term interaction, long-term caches for persistent knowledge, and shared or federated caches across devices or agents. Cached thoughts are indexed in latent space and may be retrieved using vector similarity, trajectory proximity, or geodesic alignment. Cached thoughts may be compressed or abstracted over time to reduce redundancy and support scalable reuse.

As used herein, “generalization” refers to the process of synthesizing a new thought from one or more cached thoughts by identifying shared structure, meaning, or trajectory. Generalized thoughts replace specific exemplars with compressed representations that maintain core semantic content while enabling reuse across a wider range of prompts or tasks. Generalization may occur explicitly during reasoning or asynchronously during background curation or dreaming.

As used herein, “latent manifold” refers to a differentiable subspace within a high-dimensional latent hyperspace in which thoughts and thought trajectories are embedded. The manifold may be defined at a given time and is associated with a metric tensor that governs local distance, curvature, and motion. The manifold forms dynamically through the reuse, compression, and interaction of thoughts and supports operations such as geodesic traversal, memory recall, and structural recombination.

As used herein, “geodesic attention” refers to a formulation of attention in which focus or inference is achieved by computing or approximating a minimal-energy path through the latent manifold. A geodesic attention path minimizes a cognitive action functional that may include kinetic energy, compression pressure, and goal potential. Unlike traditional attention mechanisms that reweight tokens in flat space, geodesic attention produces smooth, structure-respecting flows of reasoning across latent memory.

As used herein, “compression pressure” refers to a scalar field over the latent manifold that encodes semantic density, memory reuse, or representational redundancy. The pressure at a point may be derived from geometric properties such as Ricci curvature and reflects the cost of traversal or storage in that region. High compression pressure indicates overused or ambiguous areas where pruning, generalization, or reorganization may be necessary. Compression pressure influences cache management, memory shaping, and geodesic routing.

As used herein, “goal potential field” refers to a scalar utility function defined over the latent manifold that represents the relevance, desirability, or task-alignment of different regions of thought space. The gradient of this field defines an intent vector field, which biases cognitive traversal toward goal-aligned areas. Goal potential may be determined by user prompts, task specifications, or emergent system objectives, and modulates attention, memory retrieval, and trajectory formation.

As used herein, “intent vector field” refers to a directional field over the latent manifold that encodes cognitive drive or utility gradients. It governs the direction and magnitude of traversal for operations such as memory reentry, inference, or exploration. The intent field may be computed from the gradient of a goal potential, derived from user input, or learned from system experience, and is used to align cognitive motion with target outcomes.

As used herein, “cognitive dynamics engine” or “CDE” refers to an architectural module configured to maintain and evolve the geometry of the latent manifold. The CDE is responsible for computing geodesic paths, estimating curvature, applying compression pressure, and performing structural reorganization, including during background operations such as dreaming. The CDE may expose interfaces for traversal, memory updates, compression, and control feedback, and functions as a substrate-layer system supporting high-level cognition.

As used herein, “dreaming” refers to a background process in which cached thoughts, trajectories, or bundles are perturbed, recombined, or abstracted or otherwise manipulated to improve manifold coherence and memory efficiency. Dreaming may operate during idle cycles or low-load periods and is driven by curvature smoothing, compression pressure, and generalization gain. The process supports the emergence of new thoughts, refinement of existing structures, and long-term memory consolidation.

As used herein, “reinstantiation” refers to the act of reconstructing a prior thought trajectory within the current latent manifold geometry. Due to compression or manifold deformation, original paths may no longer exist in exact form; reinstantiation generates an approximate or adapted version guided by curvature, cached data, and intent fields. Reinstantiation supports memory recall, simulation, and introspective review in systems with dynamic cognitive substrates.

As used herein, “memory basin” or “basin of recurrence” refers to a region of the latent manifold associated with a previously reinforced or frequently reused trajectory. Such basins exhibit high local curvature and geodesic convergence and serve as attractors for memory reentry. Traversal into a basin may trigger reinstantiation, memory reinforcement, or adaptive reuse, depending on system configuration and goal conditions.

As used herein, “typed latent entity” refers to a thought or substructure in the manifold labeled with a semantic or functional type, such as but not limited to fact, opinion, concept, trajectory, affect, cluster, or anchor. Typed entities impose constraints on valid operations such as recombination, interpolation, or pruning. Type-aware computation supports lawful memory manipulation, structured reasoning, and generalization without semantic distortion.

As used herein, “attention vector field” refers to a distributed, time-dependent field defined over the latent manifold that governs the instantaneous direction and magnitude of attentional flow. The field may evolve according to partial differential equations that incorporate compression pressure and goal potential gradients. This dynamic attention formulation enables real-time flow modeling, inference stabilization, and explainability through traceable vector paths.

As used herein, “latent subspace” or “thought bundle” refers to a localized, compressible region of the manifold that contains structurally similar or semantically aligned thoughts. Bundles may form naturally through repeated traversal, co-activation, or recombination, and act as low-energy attractors or semantic zones. Subspaces may support generalization, analogical reasoning, and efficient memory access.

As used herein, “latent recombinator” refers to a functional component or method configured to merge or blend similar thoughts, trajectories, or bundles in the latent manifold to form new abstractions. The recombinator may use geometric proximity, semantic alignment, or reuse statistics to determine possible recombinations, subject to type constraints and curvature continuity. It serves as a key mechanism for memory scaling, abstraction, and thought generation.

As used herein, “structured memory” refers to a persistent, geometry-aware memory architecture in which thoughts are stored not as flat vectors but as positions or paths within an evolving manifold. Structured memory supports context-sensitive access, memory reinforcement through traversal, lawful pruning, and dynamic generalization. It provides a substrate for long-term cognition, introspection, and identity continuity in systems with persistent reasoning capability.

As used herein, “Lorentzian autoencoder” refers to a neural architecture designed to encode spatiotemporal or perceptual input—such as video—into a latent manifold with Lorentzian signature, where one or more dimensions represent time-like directions. The latent structure supports temporally coherent geodesics, semantic compression, and causal continuity. Lorentzian autoencoders enable operations such as zooming, projection, and visual memory traversal.

### Conceptual Architecture

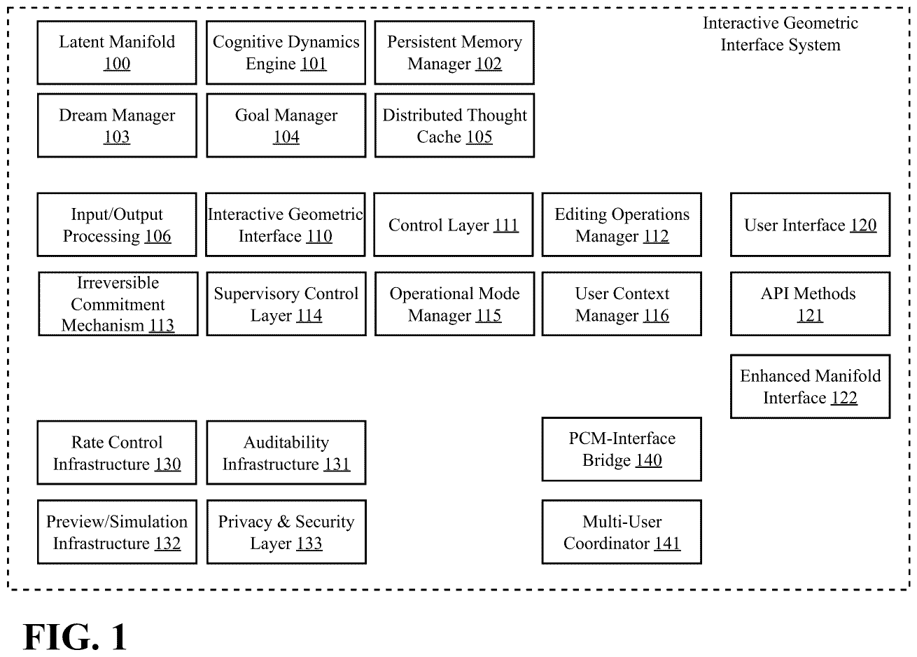

FIG. 1 is a block diagram illustrating an exemplary system architecture for an interactive geometric interface system configured to enable user engagement with persistent cognitive manifolds, according to an embodiment. The system architecture comprises a plurality of component groups organized into various functional categories, providing a comprehensive framework for governed user interaction with structured internal cognitive representations maintained by a computational system.

Various foundational components provide the underlying geometric cognitive substrate upon which the interactive interface system operates. A latent manifold 100 serves as the central cognitive substrate, implementing a continuously evolving geometric space where cognitive operations unfold. The latent manifold 100 maintains variable curvature, dynamic topology, and internal structure shaped by cognitive activity, memory consolidation, and goal-directed reasoning. Within manifold 100, thought bundles represent compact submanifolds with semantic coherence, while compression pressure fields and goal potential fields create a non-uniform landscape guiding efficient cognitive traversal.

A cognitive dynamics engine 101 operatively couples to the latent manifold 100 and manages geometric operations on thought structures within the manifold. The cognitive dynamics engine 101 implements geometry management, curvature computation, geodesic path solving, attention flow computation, and memory operation management. Through these operations, engine 101 orchestrates how attention flows through the manifold by calculating optimal paths that minimize cognitive effort while maximizing goal achievement. The engine 101 monitors and adjusts compression pressure throughout the manifold space, with regions of high concept convergence requiring greater cognitive effort to traverse, while sparse areas permit free exploration.

A persistent memory manager 102 interfaces with the latent manifold 100 to maintain geometric structures across system restarts and extended operational periods. The persistent memory manager 102 implements geometric structure preservation, activation energy tracking, thermodynamic decay management, and caching strategy optimization. Unlike traditional memory systems storing static data, the persistent memory manager 102 maintains memory as living geometric structures subject to natural evolution through usage patterns and energy dissipation. The manager 102 coordinates between local and shared cache spaces, implementing policies for preserving thoughts based on geometric and semantic criteria rather than simple recency metrics.

A dream manager 103 performs autonomous manifold reorganization during idle periods or background processing cycles. The dream manager 103 implements thought perturbation, thought recombination, curvature editing, topological operations, and memory pruning. Through these operations, the dream manager 103 explores the stability of existing structures, synthesizes new abstractions, optimizes geometric landscapes, and maintains cognitive efficiency. The dreaming process enables continuous improvement of internal representations without external supervision, developing increasingly sophisticated reasoning capabilities through natural evolution of the geometric substrate.

A goal manager 104 generates continuous scalar fields across the latent manifold 100 that attract attention and guide reasoning through geometric influence. The goal manager 104 translates abstract objectives, user queries, and system intentions into structured force fields that interact with the manifold's compression landscape. Through goal identification, goal encoding, potential field generation, gradient computation, and field dynamics calculation, the goal manager 104 creates motivational landscapes that enable purposeful yet flexible cognitive behavior adapting to changing objectives and discovering unexpected solutions through geometric dynamics.

A distributed thought cache infrastructure 105 provides multi-tiered caching capabilities operating on geometric principles rather than traditional key-value storage. The infrastructure 105 enables logarithmic scaling of memory requirements even under continuous operation across federated instances. Through local caches, shared cache spaces, and distributed cache controllers, the infrastructure 105 maintains frequently accessed geometric structures in full fidelity while implementing intelligent compression and federation strategies for broader memory distribution.

An input/output processing component 106 handles encoding of external inputs into geometric representations and decoding of geometric states into consumable outputs. The component 106 implements encoding operations that project inputs into the dynamic geometric space of the latent manifold 100, multi-stage language processing for semantic structure generation, decoding operations that transform geometric representations into interpretable forms, and output generation formatting results for user consumption or system action.

An interactive geometric interface 110 serves as the principal component enabling direct user engagement with the persistent cognitive manifold 100. The interactive geometric interface 110 presents the cognitive manifold as a set of navigable regions, relationships, or coordinates corresponding to structured internal representations. User interaction with the interface 110 may be interpreted as requests to traverse, inspect, or otherwise engage with specific portions of persistent internal state. The interface 110 implements manifold visualization, geometric navigation control, user action interpretation, spatial representation rendering, and multimodal interface adaptation. Through these capabilities, the interface 110 enables users to inhabit the manifold as a navigable and editable space rather than an opaque processing substrate.

A control layer 111 governs all interaction between users and the persistent cognitive manifold 100. The control layer 111 enforces policies relating to computational accessibility, rate of state evolution, and irreversible commitment. Through accessibility policy management, computational accessibility control, traversal permission evaluation, rate control, access level arbitration, and hierarchical access management, the control layer 111 mediates all user-directed operations to ensure they occur within architectural constraints. The control layer 111 maintains accessibility policies defining allowable traversal paths and accessible regions within the cognitive manifold, determining which portions of persistent internal state are reachable during any given processing cycle independent of full representational capacity.

An editing operations manager 112 mediates structural modifications to the cognitive manifold proposed through user interaction. The editing operations manager 112 handles modification proposals, validates structural changes, regulates edit magnitude, provides preview and simulation capabilities, initiates consolidation processes, and controls pruning operations. Editing operations may include introducing new internal representations, modifying relationships among existing representations, restructuring manifold regions, or initiating geometric reorganization. All proposed modifications are evaluated by the control layer 111 and editing operations manager 112 prior to execution, ensuring stability and predictable evolution.

An irreversible commitment mechanism 113 manages permanent state transitions within the cognitive manifold. The irreversible commitment mechanism 113 evaluates commitment thresholds, tracks structural time, manages confirmation processes, executes committed modifications, analyzes reversibility constraints, and archives state history. Once a modification is committed through the mechanism 113, the resulting change may not be fully reversible, thereby advancing a notion of structural time within the system. This irreversibility enables the system to avoid oscillation among alternatives and build coherent long-term structure while maintaining audit records describing prior states without restoring full accessibility to superseded representations.

A supervisory control layer 114 monitors and regulates interaction between users and the cognitive manifold to enforce system-level constraints and policies. The supervisory control layer 114 maintains constraint policies, monitors stability, detects inconsistencies, controls interventions, generates audit records, logs timestamps and structural time markers, and manages user permissions. Upon detecting conditions indicative of instability, inconsistency, or undesired behavior, the supervisory control layer 114 may restrict accessibility, delay or deny editing operations, or initiate consolidation processes to restore stability. The layer 114 supports auditability through generation and maintenance of records associated with interaction and modification events.

An operational mode manager 115 controls the interaction paradigm governing user engagement with the cognitive manifold. The operational mode manager 115 implements mode selection, exploration mode control, assisted editing mode control, direct editing mode control, mode transition management, and mode policy enforcement. In exploration mode, user interaction is limited to traversal and inspection without modification of persistent internal state. In assisted editing mode, user interaction may propose modifications subject to additional mediation, preview, and simulation. In direct editing mode, user-directed modifications may be committed with reduced mediation, subject to applicable constraints. The operational mode manager 115 dynamically selects or transitions among modes based on user context, system state, or supervisory policy.

A user context manager 116 maintains user-specific interaction state and preferences across interaction sessions. The user context manager 116 tracks user state, manages preferences, stores permissions, logs interaction history, and aggregates contextual information. Through these capabilities, the manager 116 enables personalized interaction patterns, appropriate accessibility enforcement, and continuity of user experience across extended operational periods.

The system architecture incorporates a third category of hybrid components, designated with reference numbers 120 through 122, which extend base components from the parent application to support interactive geometric operations. An enhanced user interface 120 extends the base user interface from the parent application to support geometric interaction operations. The enhanced user interface 120 implements capabilities including manifold region visualization, coordinate and position display, relationship visualization, interactive editing controls, and support for graphical, textual, and spatial rendering modalities. Through these enhancements, the interface 120 enables users to perceive and interact with structured cognitive representations directly rather than solely through conversational or command-based paradigms.

Enhanced API methods 121 extend the application programming interface of the cognitive dynamics engine 101 to support interface-specific operations. The API methods 121 provide programmatic access to traversal requests, accessibility checks, edit proposals, modification previews, commitment operations, accessible region queries, structural time queries, and audit trail retrieval. These methods abstract complex geometric computations while providing powerful primitives for governed user interaction with persistent cognitive state.

An enhanced manifold interface 122 extends the base manifold interface component of the persistent memory manager 102 to support user-directed operations. The enhanced manifold interface 122 implements capabilities including user-initiated geometric queries, region selection and inspection, interactive structure modification, and real-time accessibility updates. Through bidirectional communication with both the latent manifold 100 and the interactive geometric interface 110, the enhanced interface 122 enables governed user interaction with persistent geometric structures.

A rate control infrastructure 130 regulates the frequency, depth, and magnitude of user-directed operations to prevent excessive or destabilizing interaction with the cognitive manifold. The infrastructure 130 implements traversal rate limiting, edit frequency governance, magnitude change limitation, resource throttling, and burst control. Through these mechanisms, the infrastructure 130 ensures user interaction does not overwhelm system resources or compromise long-horizon coherence of persistent internal state.

An auditability infrastructure 131 maintains comprehensive records of interaction and modification events to support transparency, review, and analysis of manifold evolution. The infrastructure 131 implements audit record storage, event logging, timestamp management, structural time coordination, trace information preservation, and audit query interfaces. The maintained records include identifiers of affected representations, temporal markers, user identifiers, and descriptions of executed operations, enabling inspection of how the cognitive manifold has evolved over time without requiring full reversibility of committed changes.

A preview/simulation infrastructure 132 enables users to assess potential consequences of proposed modifications prior to irreversible commitment. The infrastructure 132 implements manifold state cloning, hypothetical modification execution, impact analysis, consequence prediction, and simulation result rendering. Through these capabilities, users may preview or simulate proposed edits, evaluate system feedback regarding anticipated effects, conflicts, or policy constraints before committing modifications to persistent internal state.

A privacy and security layer 133 protects geometric data and enforces access control policies appropriate for consumer-facing deployments. The layer 133 implements geometric data encryption, access control enforcement, user permission validation, privacy policy management, and secure channel management. Through these mechanisms, the layer 133 ensures experiential and cognitive data remains protected while still enabling meaningful geometric operations and, where appropriate, collaborative sharing capabilities.

A PCM-interface bridge 140 connects inherited PCM components with the new interface layer, providing translation, synchronization, and coordination services. The bridge 140 implements state synchronization between the latent manifold 100 and interface components, command translation between interface operations and geometric operations, event dispatching, bidirectional communication management, and geometric transformation adaptation. Through these capabilities, the bridge 140 enables seamless integration of interactive geometric capabilities with the foundational persistent cognitive architecture.

A multi-user coordination component 141 manages shared or collaborative cognitive manifolds where multiple users interact with overlapping or partially shared internal structures. The component 141 implements user session management, access partition control, shared region coordination, conflict resolution, and collaborative edit merging. Through these capabilities, the component 141 enforces user-specific accessibility and editing permissions, allowing individual users to inhabit personalized submanifolds while contributing to shared structures subject to supervisory governance.

User interaction flows from the enhanced user interface 120 through the interactive geometric interface 110 to the control layer 111, which mediates access to the persistent cognitive manifold 100. Editing operations proceed from the interface 110 through the control layer 111 to the editing operations manager 112 and irreversible commitment mechanism 113, subject to oversight by the supervisory control layer 114. The PCM-interface bridge 140 coordinates between components 100-106 and interface layer components 110-116, while supporting infrastructure components 130-133 provide rate control, auditability, preview, and security services throughout the system.

The architecture preserves the geometric cognitive capabilities of the PCM systems disclosed herein while introducing interactive mechanisms permitting users to navigate, inspect, and selectively modify structured internal representations. Through enforcement of accessibility constraints, rate limitations, irreversible commitment protocols, and supervisory oversight, the architecture maintains stability, predictability, and auditability suitable for long-horizon operation in consumer-facing cognitive systems.

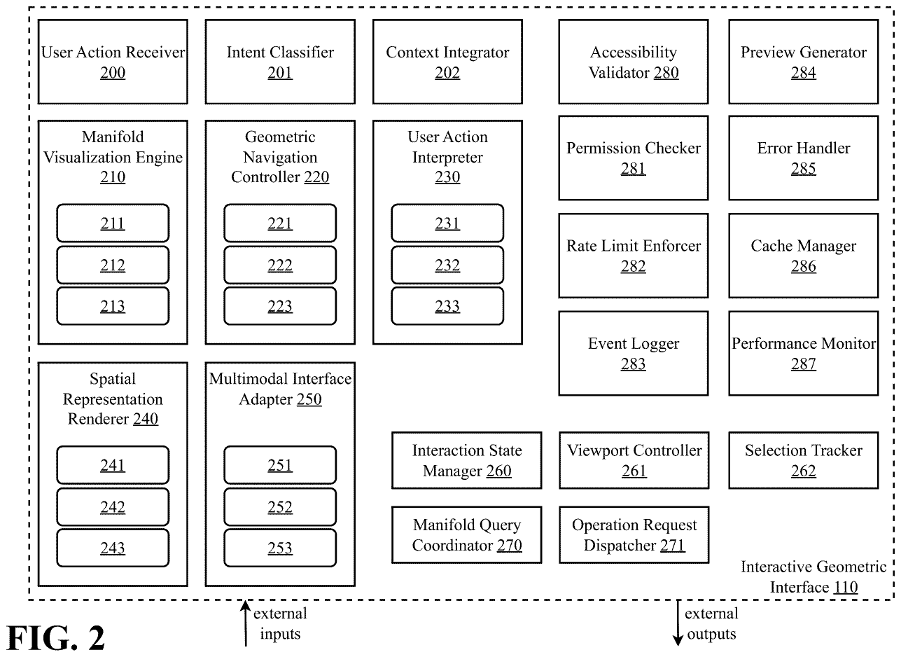

FIG. 2 is a block diagram illustrating an exemplary detailed architecture of an interactive geometric interface 110, according to an embodiment. The interactive geometric interface 110 serves as the principal component enabling direct user engagement with persistent cognitive manifolds maintained by the system, implementing a multi-layered architecture comprising input processing, core geometric operations, rendering and representation, state management, coordination, and supporting infrastructure components.

The architecture receives inputs from external components. An enhanced user interface 120 provides user interaction events including, but not limited to, touch inputs, gestures, voice commands, and pointer movements. A user context manager 116 supplies contextual information including user preferences, interaction history, and permission specifications. A latent manifold 100 provides geometric structures and manifold state information for visualization and navigation operations. These exemplary external inputs flow into the input layer of the interactive geometric interface 110 for initial processing and classification.

The input layer comprises components designated with reference numbers 200-202 and implements initial reception and interpretation of user interactions. A user action receiver 200 receives and buffers incoming user interactions from the enhanced user interface 120. The receiver 200 handles multiple input modalities including, but not limited to, touch events, gestures, voice commands, keyboard input, and pointer movements, implementing buffering mechanisms to manage varying input rates and ensure smooth processing of interaction streams. Raw action events can be forwarded from the receiver 200 to subsequent processing stages.

An intent classifier 201 analyzes user actions received from the user action receiver 200 to determine intended operation types. The classifier 201 implements pattern recognition and machine learning techniques to categorize user actions into operation classes including traversal requests, inspection queries, edit proposals, mode changes, and navigation commands. The classification process generates confidence scores indicating the certainty of intent determination, enabling downstream components to handle ambiguous inputs appropriately. Classified intent signals flow from the classifier 201 to context integration.

A context integrator 202 combines classified user intent from the intent classifier 201 with current system context obtained from user context manager 116. The integrator 202 accesses contextual information including user preferences that influence operation interpretation, interaction history providing temporal context, current viewport state determining spatial context, and accessibility permissions constraining allowable operations. Through integration of intent and context, component 202 produces contextualized action requests that flow to the core processing layer for geometric interpretation and execution.

The core processing layer implements various subsystems for manifold visualization, geometric navigation, and user action interpretation. A manifold visualization engine 210 transforms geometric manifold structures obtained from latent manifold 100 into visual representations suitable for user perception. The engine 210 receives manifold geometry including curved surfaces, topological structures, and semantic relationships, along with viewport parameters determining view frustum and rendering detail. The visualization engine 210 comprises specialized rendering components implementing distinct visualization functions.

A geometry renderer 211 within the visualization engine 210 renders geometric structures including manifold regions, thought bundles, and geodesic paths. The renderer 211 implements techniques for curved surface rendering that preserve geometric fidelity, geodesic path visualization showing optimal traversal routes, and topological structure display revealing connectivity and relationships. Rendering operations account for the non-Euclidean geometry of the manifold space, implementing appropriate projection and display transformations.

A relationship mapper 212 visualizes relationships and connections between manifold regions. The mapper 212 displays semantic proximity through spatial arrangement or visual linking, causal links indicating influence relationships, temporal sequences showing evolution over structural time, and resonance patterns revealing meaningful connections discovered by the experiential resonance engine. Through these visualizations, users perceive the relational structure of the cognitive manifold beyond geometric proximity alone.

A region highlighter 213 emphasizes specific manifold regions based on relevance, selection, or system state. The highlighter 213 implements multiple highlighting modes including visualization of accessibility levels indicating which regions are currently reachable, display of search results marking regions matching query criteria, indication of current focus showing the user's present position or attention, and identification of modification targets highlighting regions subject to proposed edits. Visual emphasis techniques include color coding, boundary outlining, transparency variation, and animated effects.

A geometric navigation controller 220 manages user traversal through the cognitive manifold space, implementing path planning, position tracking, and boundary enforcement to enable governed exploration of persistent internal state. The controller 220 coordinates with the control layer 111 to validate accessibility of navigation operations, ensuring traversal requests comply with accessibility policies and permission constraints. The navigation controller 220 comprises specialized components implementing distinct navigation functions.

A traversal path planner 221 within navigation controller 220 computes valid paths between manifold regions requested through user navigation actions. The planner 221 generates multiple path types including geodesic paths following minimal-distance routes through the curved manifold geometry, accessibility-constrained routes respecting permission boundaries and rate limits, and exploration sequences designed for systematic discovery of manifold structures. Path computation incorporates constraints including, for example, rate limits on traversal frequency, permission boundaries defining accessible regions, and stability requirements avoiding unstable or dangerous manifold areas.

A position tracker 222 maintains current user position within manifold space as navigation operations execute. The tracker 222 maintains state information including, but not limited to, manifold coordinates identifying precise location, region identity indicating which thought bundle or semantic area contains the position, local metric characterizing distance relationships near the current position, and compression pressure quantifying cognitive density at the location. Position updates broadcast in real-time to the state management layer enable coordinated updates across interface components as navigation proceeds.

A boundary detector 223 identifies accessibility boundaries and traversal limits encountered during navigation operations. The detector 223 performs continuous detection of permission boundaries where accessibility policies restrict further traversal, rate limit thresholds where navigation frequency approaches or exceeds allowed rates, and unstable regions where manifold geometry exhibits dangerous curvature or topological features. Upon boundary detection, component 223 generates boundary warnings alerting users to limits, implements traversal prevention blocking invalid navigation, and suggests alternative path options enabling continued exploration within constraints.

A user action interpreter 230 translates user actions into geometric operations executable within the manifold framework. The interpreter 230 processes multiple input types including, but not limited to, gestures representing continuous spatial interactions, commands comprising discrete structured directives, and continuous interactions involving sustained user engagement. Translation produces structured operation requests specifying operation type, parameters, priority, and resource requirements. The interpreter 230 comprises specialized analysis components implementing distinct interpretation functions.

A gesture analyzer 231 within the action interpreter 230 interprets spatial gestures and continuous interactions. The analyzer 231 recognizes gesture patterns including swipe gestures indicating traversal requests, pinch gestures controlling zoom or scale, rotation gestures adjusting viewport orientation, tap gestures selecting regions or elements, and hold gestures requesting detailed inspection. Gesture recognition employs pattern matching, machine learning classification, and temporal analysis to distinguish gesture types and extract parameters from continuous interaction streams.

A command parser 232 processes discrete commands and structured inputs. The parser 232 handles multiple command types including navigation directives specifying target regions or traversal paths, search queries identifying manifold elements matching criteria, edit specifications proposing structural modifications, and mode switches requesting operational mode transitions. Parsing operations validate command syntax, extract parameters, resolve references to manifold elements, and generate structured command representations for subsequent processing.

An operation mapper 233 maps interpreted actions from the gesture analyzer 231 and command parser 232 to allowable geometric operations. The mapper 233 implements translation from high-level user actions to low-level geometric operations including manifold queries, traversal requests, edit proposals, and state modifications. Mapping operations determine operation type classification, extract and validate parameters, assign priority based on user context and system state, and estimate resource requirements for scheduling and throttling purposes. Mapped operations flow to rendering and state management layers for execution and visualization.

The rendering and representation layer comprises components for spatial rendering and multimodal adaptation. A spatial representation renderer 240 renders spatial properties and geometric metrics of the manifold for user perception. The renderer 240 displays coordinates indicating position within the manifold space, distances quantifying relationships between regions, curvatures characterizing local geometric properties, and densities representing compression pressure or semantic concentration. Multiple rendering modes support diverse interaction contexts including 2D projection for standard displays, 3D immersive rendering for virtual reality environments, and abstract topological visualization emphasizing connectivity over geometric embedding.

A coordinate display 241 within spatial renderer 240 shows current position coordinates within the manifold. The display 241 supports multiple coordinate formats including, for instance, local chart coordinates specific to the current manifold region, global manifold coordinates providing system-wide position reference, and semantic labels offering human-readable position descriptions. Coordinate presentation adapts to user expertise and context, providing technical precision when appropriate and intuitive descriptions when preferred.

A metric visualizer 242 visualizes metric tensor properties and distance relationships within the manifold. The visualizer 242 displays distance fields showing proximity to selected reference points, metric distortion illustrating how local geometry deviates from Euclidean space, and geodesic distances quantifying minimal-path lengths between regions. Visualization techniques include color gradients encoding metric values, contour lines delineating constant-metric surfaces, and vector fields indicating metric gradients.

A curvature indicator 243 indicates local manifold curvature and compression pressure. The indicator 243 employs visual encoding techniques including color gradients mapping curvature magnitude to hue or saturation, contour lines outlining constant-curvature regions, and density patterns representing compression through visual texture or opacity. High curvature regions indicating semantic density or cognitive compression appear visually distinct from low curvature areas representing sparse or simple conceptual spaces.

A multimodal interface adapter 250 adapts interface outputs to multiple sensory modalities beyond visual display. The adapter 250 supports visual, haptic, and auditory modalities, implementing cross-modal coherence ensuring consistent representations across modalities and sensory fusion enabling integrated multimodal experiences. Through multimodal adaptation, the interface accommodates diverse user preferences, accessibility requirements, and interaction contexts.

A visual adapter 251 within the multimodal adapter 250 formats visual displays for different rendering contexts. The adapter 251 generates outputs including screen displays for conventional monitors, virtual reality/augmented reality (VR/AR) rendering for immersive environments, and projection mapping for spatial display systems. Visual adaptation handles resolution scaling, color space conversion, and rendering optimization appropriate to each display technology.

A haptic adapter 252 generates haptic feedback representing geometric properties of the manifold. The adapter 252 produces force feedback conveying curvature through resistance or attraction, vibration patterns indicating boundaries or transitions, and texture sensations representing density or compression. Haptic rendering enables tactile exploration of geometric structure, supporting accessibility and enhancing spatial understanding through kinesthetic engagement.

An audio adapter 253 provides audio representations of manifold features. The adapter 253 implements sonification techniques generating audio cues including pitch or timbre variations representing curvature magnitude, spatial audio providing navigational guidance through directional sound, and alert tones indicating boundary warnings or system notifications. Audio adaptation supports accessibility for visually impaired users and provides supplementary information channels during complex navigation tasks.

The state management layer maintains interaction session state and viewport configuration. An interaction state manager 260 maintains current interaction session state including active operations being executed, pending requests awaiting processing, interaction history recording recent actions, and undo/redo stack supporting action reversal. State persistence mechanisms ensure session continuity across interruptions, enabling users to resume interactions after temporary disconnection or system restart.

A viewport controller 261 manages viewport parameters and view transformations controlling how manifold geometry is presented to users. The controller 261 maintains parameters including viewport position within manifold space, orientation determining viewing direction, zoom level controlling visual scale, and focus region identifying the primary area of interest. Viewport operations include pan translating viewport position, zoom adjusting visual magnification, rotate changing viewing orientation, reset returning to default view, and bookmark views storing named viewport configurations for rapid recall.

A selection tracker 262 tracks user selections and focused elements within the manifold visualization. The tracker 262 maintains records of selected regions marked for inspection or editing, highlighted paths designated for traversal analysis, and bookmarked positions saved for future reference. Multi-selection support enables complex selection operations involving multiple disconnected regions, composite selections spanning multiple manifold areas, and hierarchical selections capturing nested structures.

The coordination layer manages communication with external components and internal request routing. A manifold query coordinator 270 coordinates queries to the latent manifold 100 for geometric information and structure access. The coordinator 270 handles multiple query types including structure queries retrieving manifold topology, relationship queries identifying connections between regions, and metric queries computing distances or curvatures. Query optimization techniques including batching, caching, and prefetching improve performance and reduce computational overhead. The coordinator 270 implements bidirectional communication with enhanced manifold interface 122, enabling both query submission and update notification.

An operation request dispatcher 271 dispatches operation requests to appropriate external components for validation, authorization, and execution. The dispatcher 271 routes requests to multiple targets including control layer 111 for accessibility and permission validation, operational mode manager 115 for mode-specific processing, and other interface components as appropriate. Dispatch operations handle multiple request types including traversal requests proposing navigation operations, edit proposals suggesting structural modifications, and mode changes requesting operational transitions. Request routing implements priority-based scheduling ensuring critical operations receive timely processing and dependency management coordinating related operations.

Supporting components positioned to the right of the main interface container provide cross-cutting services including validation, permission checking, rate limiting, logging, preview generation, error handling, caching, and performance monitoring. An accessibility validator 280 validates accessibility of requested operations against current accessibility policies. The validator 280 performs permission checks verifying user authorization and accessibility policy evaluation determining whether manifold regions or operations are currently accessible. Validation sources include accessibility policies from control layer 111 and user permissions from user context manager 116.

A permission checker 281 verifies user permissions for specific operations beyond general accessibility validation. The checker 281 performs granular permission checks including read permissions controlling information access, write permissions authorizing modifications, and mode-specific permissions governing operations available only in particular operational modes. Permission policies integrate with supervisory control layer 114 to enforce system-wide governance constraints.

A rate limit enforcer 282 enforces rate limits on user operations to prevent excessive interaction or destabilizing behavior. The enforcer 282 applies limits including traversal frequency restricting navigation rate, edit rate constraining modification frequency, and query volume limiting information retrieval operations. Enforcement actions include request throttling delaying operations to comply with limits, burst allowance permitting temporary rate exceedance, and backpressure signaling informing upstream components of rate constraint conditions.

An event logger 283 logs all interface events for auditability and analysis purposes. The logger 283 records multiple event types including user actions capturing interaction details, system responses documenting interface behavior, state changes tracking configuration modifications, and errors preserving failure information. Logged events integrate with the auditability infrastructure 131 to support comprehensive audit trails, system analysis, and debugging.

A preview generator 284 generates previews of proposed operations enabling users to assess consequences before commitment. The generator 284 produces multiple preview types including edit previews visualizing anticipated modifications, traversal outcomes showing expected navigation results, and state projections predicting system configuration after operation execution. Preview generation integrates with the preview/simulation infrastructure 132 to leverage manifold state cloning and hypothetical execution capabilities.

An error handler 285 handles errors and exceptional conditions arising during interface operations. The handler 285 implements error recovery attempting to restore normal operation, user notifications informing users of error conditions, and fallback behaviors providing degraded functionality when full operation is unavailable. Handled error types include validation failures when operations violate policies, inaccessible regions when users attempt to navigate restricted areas, and rate limit violations when operation frequency exceeds thresholds.

A cache manager 286 manages local caching of interface data to improve performance and reduce redundant computation. The manager 286 caches multiple data types including rendered visualizations avoiding re-rendering, query results eliminating redundant manifold queries, and prefetched regions anticipating likely navigation targets. Cache policies include LRU eviction removing least recently used entries, size limits constraining memory consumption, and coherence maintenance ensuring cached data remains consistent with manifold state.

A performance monitor 287 monitors interface performance metrics to detect degradation and trigger optimization. The monitor 287 tracks metrics including response latency measuring operation completion time, rendering frame rate quantifying visualization smoothness, and operation throughput counting completed operations per unit time. Monitoring actions include performance logging recording metric values, optimization triggers activating performance enhancement mechanisms, and degradation warnings alerting users or administrators to performance issues.

User interactions flow from external inputs through the input layer components 200-202, proceeding to core processing components 210-233 for interpretation and visualization. Processed operations flow through rendering components 240-253 generating multimodal outputs, then through state management components 260-262 maintaining session state, finally reaching coordination components 270-271 that dispatch requests to external components including control layer 111, enhanced manifold interface 122, and operational mode manager 115. Supporting components 280-287 connect bidirectionally with processing layers, providing validation, logging, and monitoring services throughout operation execution.

Together, these components implement a comprehensive interactive geometric interface enabling users to visualize, navigate, and interact with persistent cognitive manifolds through governed, auditable operations. The layered architecture separates concerns including input processing, core geometric operations, rendering and adaptation, state management, and external coordination, while supporting components provide cross-cutting services ensuring stable, performant, and compliant operation. Through this architecture, the interactive geometric interface 110 transforms abstract geometric structures maintained within the latent manifold 100 into perceivable, navigable spaces that users can explore and selectively modify subject to appropriate governance constraints.

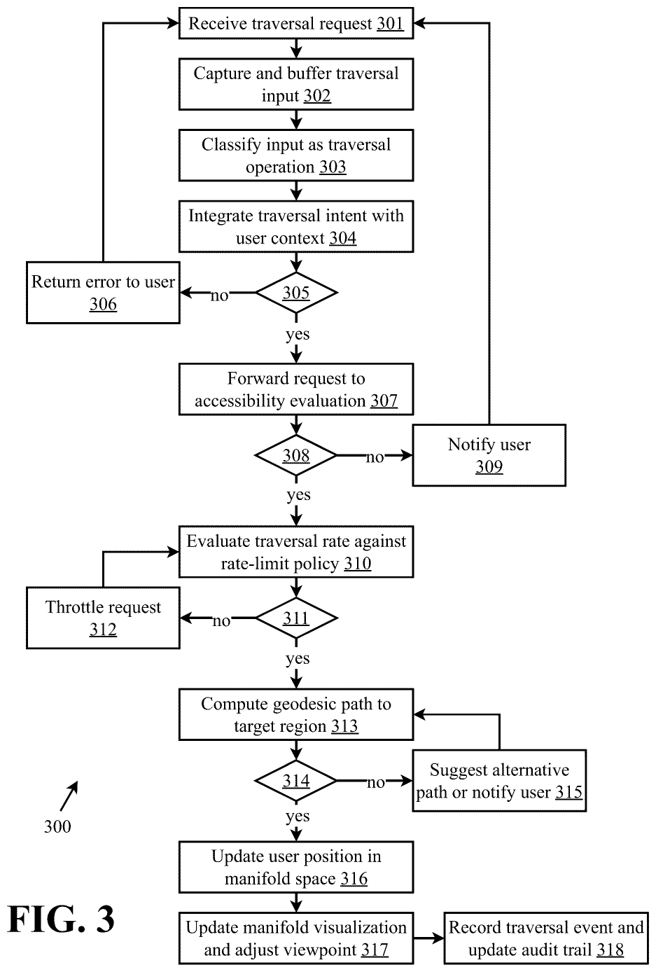

FIG. 3 is a flow diagram illustrating an exemplary method 300 for user traversal and manifold navigation, according to an embodiment. The method 300 describes a sequence of operations by which a user initiates a traversal request through the interactive geometric interface 110, the request is validated against accessibility and rate-limit policies enforced by the control layer 111, a geodesic path through the latent manifold 100 is computed, and the user's position is updated together with corresponding visualization and audit operations. The method 300 further describes alternate processing paths arising from malformed requests, inaccessible regions, rate-limit violations, and path-planning failures, ensuring that navigation operations remain bounded, auditable, and consistent with system governance constraints.

According to the embodiment, the process begins at step 301, at which a user initiates a traversal request through the interactive geometric interface 110. A traversal request may be initiated through any supported interaction modality, including but not limited to swipe or drag gestures indicating a desired direction of movement, explicit navigation commands specifying a target region or coordinate, voice directives, or selection of a destination element within the manifold visualization. The nature of the traversal request is not limited to any particular form; any user action interpretable as an instruction to move from a current position to another region within the persistent cognitive manifold constitutes a traversal request for purposes of the present method.

At step 302, the user action receiver 200 captures and buffers the traversal input received from the enhanced user interface 120. The receiver 200 implements buffering mechanisms configured to accommodate varying input rates and to ensure that traversal inputs are not lost under transient processing load. Raw action events representing the captured traversal input are queued for forwarding to subsequent processing stages.

At step 303, the intent classifier 201 classifies the buffered action as a traversal operation. The classifier 201 analyzes the captured input using pattern recognition and classification techniques to distinguish traversal requests from other operation types including inspection queries, edit proposals, and mode change requests. The classification process may assign a confidence score to the traversal classification, and may generate alternative classifications in the event of ambiguous input.

At step 304, the context integrator 202 combines the classified traversal intent with current user context obtained from the user context manager 116. Contextual information incorporated at this step may include user preferences governing traversal behavior, interaction history providing temporal context relevant to interpretation of the request, the current viewport state establishing the spatial context of the request, and user-specific accessibility permissions constraining the regions reachable by this user. The integrator 202 produces a contextualized traversal request incorporating both the geometric target or direction and the applicable contextual parameters.

At decision point 305, the method determines whether the traversal request is well-formed. A traversal request is considered well-formed if it specifies a target or direction interpretable within the coordinate system of the cognitive manifold, contains parameters within acceptable ranges, and does not exhibit syntactic or semantic errors that would prevent processing. If the request is not well-formed, the method proceeds to step 306, at which an error response is returned to the user through the error handler 285, and the method terminates the current traversal attempt. If the request is well-formed, the method proceeds to step 307.

At step 307, the operation request dispatcher 271 forwards the contextualized traversal request to the control layer 111 for policy evaluation. The dispatcher 271 performs request formatting and priority assignment prior to submission, ensuring that the traversal request is presented to the control layer 111 in a form suitable for policy evaluation.

At decision point 308, the accessibility validator 280 evaluates whether the requested traversal is permitted under current accessibility policies. The validator 280 consults accessibility policies maintained by the control layer 111 and user permissions stored in the user context manager 116 to determine whether the target region is computationally accessible to the requesting user at the current time. Accessibility determinations may account for region-specific access restrictions, user permission levels, current system state, and prior commitments that may have altered the accessibility of certain manifold regions. If the accessibility validator 280 does not grant permission, the method proceeds to step 309, at which the user is notified that the requested region is inaccessible, the event is recorded by the event logger 283, and the method returns to await a subsequent traversal request at step 301. If permission is granted, the method proceeds to step 310.

At step 310, the rate limit enforcer 282 evaluates the frequency of traversal operations initiated by the current user against applicable rate-limit policies. The enforcer 282 maintains counters and timestamps tracking the rate of recent traversal operations and compares observed rates against policy-specified thresholds. Rate-limit policies may specify limits on traversal frequency per unit time, maximum traversal depth within a session, or maximum number of distinct regions accessed within a period.

At decision point 311, the method determines whether the current traversal request falls within applicable rate limits. If the request would cause the traversal rate to exceed policy thresholds, the method proceeds to step 312, at which the request is throttled, backpressure is applied to the requesting component, and the user is notified of the rate constraint. The method thereafter returns to step 310 to re-evaluate the rate-limit condition upon expiration of the applicable throttling interval. If the traversal request is within rate limits, the method proceeds to step 313.

At step 313, the traversal path planner 221 computes a geodesic path from the user's current position to the requested target region within the curved geometry of the latent manifold 100. Path computation implements geodesic distance minimization respecting the Riemannian metric tensor of the manifold, such that the computed path follows a minimal-length route through the semantic space. Path computation additionally incorporates accessibility constraints to avoid restricted regions, rate-limit constraints to plan paths within permitted traversal scope, and stability constraints to avoid manifold areas exhibiting unstable curvature or topological features that could produce adverse navigation behavior.

At decision point 314, the method determines whether a valid path to the target region was found. A path is considered valid if it connects the current position to the target region through accessible manifold territory without violating stability constraints. If no valid path is found, the method proceeds to step 315, at which the boundary detector 223 analyzes the navigation constraints to identify alternative paths or, where no alternative exists, generates a notification informing the user of the navigation limitation. The method thereafter returns to step 313 to attempt path computation with revised parameters if an alternative is available, or to step 301 if navigation cannot be completed. If a valid path is found, the method proceeds to step 316.

At step 316, the position tracker 222 updates the user's current position within the manifold space to reflect completion of the traversal along the computed path. The position tracker 222 records updated manifold coordinates, region identity, local metric parameters, and compression pressure at the new position. Concurrently, the manifold query coordinator 270 issues queries to the latent manifold 100 via the enhanced manifold interface 122 to retrieve geometric structure information, relationships, and metric properties of the newly occupied region for use in subsequent visualization operations.

At step 317, the manifold visualization engine 210 updates the rendered view of the cognitive manifold to reflect the user's new position, incorporating updated geometric structures, relationship visualizations, and region highlights retrieved in step 316. Concurrently, the viewport controller 261 adjusts display parameters including position, orientation, and focus region to center the presentation on the newly occupied manifold region, providing the user with an appropriately oriented and scaled view of the surrounding cognitive structure.

At step 318, the event logger 283 records the completed traversal operation, capturing a representation of the event including the source region, target region, path taken, timestamps, user identifier, and any applicable policy evaluations performed during the traversal. The recorded event is forwarded to the auditability infrastructure 131, which incorporates the traversal record into the persistent audit trail maintained for the cognitive manifold. The audit trail update ensures that the traversal is available for subsequent review, analysis, or compliance verification without requiring full reversibility of the navigational state change. The method then proceeds to the terminal step 319, at which the traversal operation is complete.

It will be appreciated that variations and modifications may be made to the method 300 without departing from the scope of the present disclosure. For example, certain steps may be performed concurrently, additional validation steps may be interposed, or the order of rate-limit evaluation and accessibility validation may be reversed depending on system configuration. Steps describing notifications to users are exemplary and may be omitted or modified in implementations where user feedback is handled by other means. Furthermore, while the method 300 describes traversal to a single target region, the method may be extended to support multi-segment traversal sequences or continuous navigation through successive manifold regions.

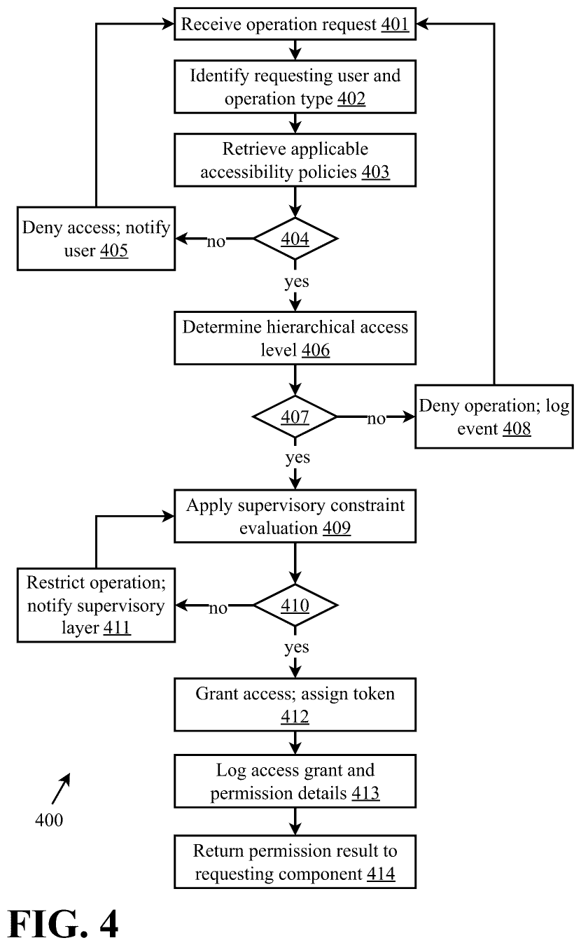

FIG. 4 is a flow diagram illustrating an exemplary method 400 for controlled accessibility and permission evaluation, according to an embodiment. The method 400 describes a sequence of operations by which the system evaluates whether a requesting user is authorized to perform a proposed operation upon a region or structure within the persistent cognitive manifold. The method 400 implements a multi-stage evaluation pipeline comprising region accessibility determination, hierarchical user permission assessment, and supervisory constraint verification, with each stage capable of independently denying the requested operation. Through this pipeline, the system enforces governance policies that ensure only appropriately authorized operations proceed to execution, while denied operations are logged and the requesting component is notified of the disposition.

According to the embodiment, the process begins at step 401, at which the system receives an operation request from a requesting component. Operation requests subject to the method 400 may include any request to traverse, inspect, modify, or otherwise interact with a region or structure within the persistent cognitive manifold, including but not limited to traversal requests, edit proposals, inspection queries, and mode change requests. The method 400 is not limited to any particular operation type; any operation requiring authorization under applicable accessibility policies may be processed according to the method.

At step 402, the system identifies the requesting user and the type of operation being requested. User identification may be accomplished through any suitable authentication or session management mechanism, including but not limited to session tokens, user identifiers propagated through the request, or contextual information maintained by user context manager 116. Operation type identification classifies the requested operation into a category used in subsequent policy evaluation, such as read, traversal, write, modification, or administrative operation. The combination of user identity and operation type forms the basis for policy lookups performed in subsequent steps.

At step 403, the system retrieves the accessibility policies applicable to the identified user and operation type. Accessibility policies may be stored within control layer 111 and may be organized by user identifier, user role, operation category, target region, current system state, or combinations thereof. Retrieved policies specify the conditions under which the requested operation is permitted, the access level granted upon satisfaction of those conditions, and any constraints or rate limits applicable to the operation. Policy retrieval may incorporate inheritance mechanisms where user-specific policies supplement or override role-based or default policies.

At decision point 404, the method determines whether the target region of the requested operation is computationally accessible under the retrieved policies. A region is computationally accessible if it falls within the set of regions designated as reachable for the requesting user at the current time, as defined by the applicable accessibility policies. Accessibility may depend on factors including the current operational mode, prior commitments that have altered regional accessibility, temporal constraints specifying periods of permitted access, and system state conditions that may restrict access to certain regions. If the target region is not accessible, the method proceeds to step 405, at which access is denied and the requesting user or component is notified of the inaccessibility. The denial event is recorded and the method returns to step 401 to await subsequent requests. If the target region is accessible, the method proceeds to step 406.

At step 406, the system determines the hierarchical access level applicable to the requesting user for the identified operation and target region. Hierarchical access levels define a graded taxonomy of permitted operations, such that higher access levels permit a broader set of operations than lower levels. Access level determination may account for the user's base permission tier, any elevated permissions granted for specific regions or operation types, temporary permission elevations arising from supervisory approval, and any restrictions applied as a result of prior interaction history. The determined access level is used in the subsequent permission sufficiency evaluation.

At decision point 407, the method determines whether the requesting user's permission level is sufficient to authorize the requested operation at the determined access level. A user's permission is considered sufficient if the access level determined at step 406 encompasses the requested operation type and satisfies any additional permission criteria specified in the applicable policies. If user permission is not sufficient, the method proceeds to step 408, at which the operation is denied, a denial event is logged to auditability infrastructure 131, and the method returns to step 401. If user permission is sufficient, the method proceeds to step 409.

At step 409, the system applies supervisory constraint evaluation to the requested operation. Supervisory constraint evaluation assesses whether the proposed operation satisfies system-level constraints maintained by supervisory control layer 114 that are independent of user-specific permissions. Such constraints may include rate of change limits specifying maximum allowable modification rates within a given interval, stability constraints ensuring the proposed operation would not destabilize the manifold geometry, consistency constraints verifying that the operation would not introduce structural inconsistencies, and operational thresholds defining maximum resource consumption or scope of effect. Supervisory constraint evaluation may also incorporate analysis of recent interaction history to detect patterns indicative of undesired behavior.

At decision point 410, the method determines whether the supervisory constraints evaluated at step 409 are satisfied. If supervisory constraints are not satisfied, the method proceeds to step 411, at which the operation is restricted, supervisory control layer 114 is notified of the constraint violation, and the method returns to step 409 for re-evaluation after any applicable remediation. Re-evaluation may occur after an interval specified by the applicable constraint policy, after the requesting user modifies the proposed operation to comply with constraints, or after supervisory approval is obtained. If supervisory constraints are satisfied, the method proceeds to step 412.

At step 412, the system grants access to the requested operation and assigns a permission token to the requesting component. The permission token encodes the authorized operation type, target region, applicable access level, and any constraints or conditions attached to the authorization. The token may include a validity period after which re-authorization is required, a scope limitation restricting the authorized operation to specific parameters, and a reference identifier enabling the authorization event to be correlated with subsequent audit records. The permission token is transmitted to the requesting component as confirmation that the operation may proceed.

At step 413, the system logs the access grant and associated permission details to auditability infrastructure 131. The logged record includes the requesting user identifier, the operation type, the target region, the access level granted, the permission token reference, a timestamp or structural time marker, and the policy evaluation path taken to reach the grant decision. Logging the access grant ensures that all authorized operations are traceable and that the audit trail reflects both granted and denied access events, supporting comprehensive review of how the cognitive manifold has been accessed and modified over time.

At step 414, the system returns the permission result, including the assigned permission token, to the requesting component. The requesting component receives confirmation of authorization together with any conditions or constraints attached to the grant, enabling it to proceed with execution of the operation within the authorized scope. If the requesting component is interactive geometric interface 110, the returned permission result enables the interface to initiate the authorized operation through the appropriate processing pipeline. The method then proceeds to the terminal step 415, at which the permission evaluation operation is complete.

It will be appreciated that the method 400 may be adapted in various ways without departing from the scope of the present disclosure. For example, the three evaluation stages at decision points 404, 407, and 410 may be performed in a different order, may be combined into a unified policy evaluation step, or may be supplemented with additional evaluation stages as required by particular deployment contexts. The denial and notification steps 405, 408, and 411 are exemplary and the specific form of user notification and event logging may vary across implementations. Furthermore, certain evaluation stages may be bypassed for specific operation types or user roles where the applicable policies do not require multi-stage evaluation. The method 400 may be invoked by any component requiring authorization evaluation, and is not limited to processing requests originating from interactive geometric interface 110.

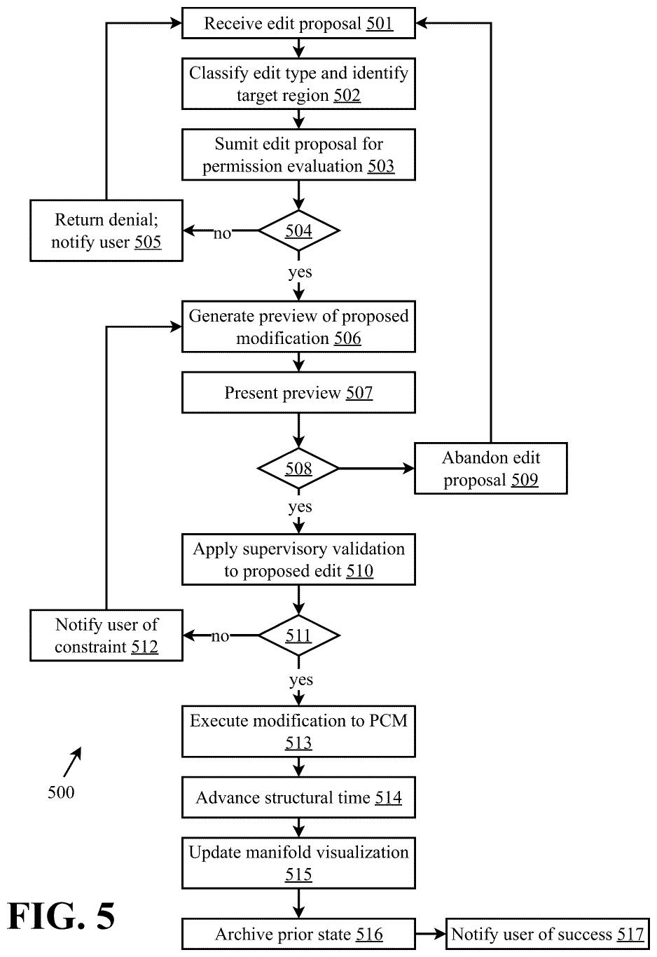

FIG. 5 is a flow diagram illustrating an exemplary method 500 for edit proposal, preview, and irreversible commitment, according to an embodiment. The method 500 describes a sequence of operations by which a user proposes a structural modification to the persistent cognitive manifold, the proposed modification is evaluated for authorization, a preview of the anticipated effects is generated and presented to the user, supervisory validation is applied, and upon satisfaction of all conditions the modification is executed and committed irreversibly to the persistent internal state. The method 500 is organized into three logical phases comprising proposal and authorization, preview and user confirmation, and commitment and audit. Through this sequence, the system enables user-directed structural evolution of the cognitive manifold while preserving stability, predictability, and auditability through layered governance controls and irreversible commitment mechanisms.

According to the embodiment, the process begins at step 501, at which the system receives an edit proposal from a user through interactive geometric interface 110. An edit proposal constitutes a user-initiated request to introduce a structural modification to the persistent cognitive manifold and may include, without limitation, a proposal to introduce a new internal representation, to modify relationships among existing representations, to restructure regions of the cognitive manifold, or to initiate consolidation or pruning of existing structures. The form of the edit proposal is not limited to any particular representation; any user action interpretable as a request to modify the persistent internal state of the cognitive manifold constitutes an edit proposal for purposes of the present method.

At step 502, the system classifies the edit type and identifies the target region of the proposed modification. Edit type classification assigns the proposal to a category of structural modification, such as representation introduction, relationship modification, regional restructuring, or geometric reorganization, based on the nature and parameters of the proposed change. Target region identification determines which portion or portions of the persistent cognitive manifold would be affected by the proposed modification. The combination of edit type and target region forms the basis for subsequent permission evaluation and supervisory constraint assessment.

At step 503, the system submits the edit proposal, together with the identified edit type and target region, for permission evaluation. The permission evaluation assesses whether the requesting user holds sufficient authorization to perform the proposed edit type upon the identified target region, and whether the target region is computationally accessible for modification under the applicable accessibility policies. The submission from step 503 initiates the permission evaluation pipeline and awaits a permission result before proceeding.

At decision point 504, the method determines whether permission for the proposed edit has been granted by the permission evaluation pipeline. If permission is not granted, the method proceeds to step 505, at which a denial response is returned to the user identifying the reason for denial, and the method returns to step 501 to await a subsequent edit proposal. The denial may indicate that the target region is inaccessible, that the user's permission level is insufficient for the proposed edit type, or that supervisory constraints preclude the operation. If permission is granted, the method proceeds to step 506.

At step 506, the system generates a preview of the proposed modification. Preview generation implements a non-destructive simulation of the proposed edit upon a clone of the current manifold state, producing a representation of the anticipated post-modification structure without altering the persistent internal state. The preview captures the structural changes that would result from execution of the proposed modification, including changes to manifold geometry, alterations to relationships among representations, and any consequential effects upon neighboring regions arising from the modification. The preview generation process may employ the preview and simulation infrastructure 132 to perform manifold state cloning, hypothetical modification execution, impact analysis, and consequence prediction.

At step 507, the system presents the generated preview and its anticipated effects to the user through interactive geometric interface 110. The presentation may include a visual rendering of the projected post-modification manifold state, a comparison view highlighting differences between the current and projected states, a description of the structural changes that would be effected, and any warnings or notifications regarding policy constraints, irreversibility, or potential effects upon adjacent manifold regions. The presentation enables the user to make an informed decision regarding whether to proceed with the proposed modification or to abandon or revise the proposal.

At decision point 508, the method determines whether the user confirms their intention to proceed with the proposed modification following review of the preview. User confirmation may be expressed through an explicit confirmation action within interactive geometric interface 110, such as a confirmation gesture, command, or approval input. If the user does not confirm, the method proceeds to step 509, at which the edit proposal is abandoned, a cancellation event is logged to auditability infrastructure 131, and the method returns to step 501. If the user confirms the intention to proceed, the method advances to step 510.

At step 510, the system applies supervisory validation to the confirmed edit proposal. Supervisory validation assesses the proposed modification against system-level constraints maintained by supervisory control layer 114 that govern the evolution of the persistent cognitive manifold. Such constraints may include limits on the magnitude of structural change permitted within a given interval, stability requirements ensuring the proposed modification would not introduce geometric instability or topological inconsistency, coherence requirements verifying that the modification preserves the semantic integrity of the manifold, and any additional constraints specified by applicable supervisory policies. Supervisory validation at this stage is applied to the confirmed proposal incorporating any parameters adjusted by the user following preview review.

At decision point 511, the method determines whether the proposed modification satisfies all applicable supervisory constraints evaluated at step 510. If supervisory validation has not passed, the method proceeds to step 512, at which the user is notified of the specific constraint or constraints that the proposed modification does not satisfy, and is invited to modify the proposal to bring it into compliance. The method returns to step 506 to generate a revised preview reflecting any modifications to the proposal made in response to the constraint notification. If supervisory validation has passed, the method proceeds to step 513.

At step 513, the system executes the proposed modification to the persistent cognitive manifold. Execution applies the structural changes specified in the confirmed and validated edit proposal to the persistent internal state, introducing new representations, modifying existing relationships, restructuring manifold regions, or performing other geometric operations as specified. Execution is performed upon the live persistent state rather than a clone, and the resulting changes constitute a permanent alteration to the cognitive manifold subject to the irreversibility constraints applied in the subsequent step.

At step 514, the system advances structural time and marks the executed modification as irreversible. Structural time advancement records the committed modification as a permanent event in the temporal history of the cognitive manifold, incrementing the structural time index to reflect that the manifold has undergone an irreversible state transition. Once marked irreversible, the modification may not be fully undone through subsequent operations; the prior state of the affected representations and relationships is no longer computationally accessible for restoration, although trace information and audit records describing the prior state are preserved as described in step 516. The irreversibility mechanism prevents oscillation among alternative structural configurations and supports the accumulation of coherent long-term structure within the cognitive manifold.

At step 515, the system updates the manifold visualization presented through the interactive geometric interface 110 to reflect the committed post-modification state. The visualization update replaces any preview rendering with an accurate representation of the actual committed manifold structure, ensuring that the user's view corresponds to the persistent internal state following execution. Updated geometric structures, revised relationship visualizations, and any region highlights reflecting the modification are incorporated into the rendered view, and viewport controller 261 adjusts the display as appropriate to present the modified region prominently.

At step 516, the system archives trace information describing the prior state of the modified manifold region and generates a comprehensive audit record of the committed modification. Archived trace information may include geometric parameters, relationship configurations, and metric properties of the affected representations prior to modification, preserved in a format suitable for retrospective analysis without enabling restoration of the prior state. The audit record generated at this step incorporates the edit type, target region, structural time marker, user identifier, permission token reference, supervisory validation outcome, and a description of the structural changes effected. The audit record is submitted to auditability infrastructure 131 for incorporation into the persistent audit trail maintained for the cognitive manifold.

At step 517, the system notifies the user of the successful commitment of the proposed modification through interactive geometric interface 110. The notification confirms that the modification has been executed, committed, and recorded, and may include a summary of the structural changes effected, the structural time marker assigned to the committed modification, and any relevant information regarding the irreversibility of the change. The method then proceeds to the terminal step 518, at which the edit proposal, preview, and irreversible commitment operation is complete.

It will be appreciated that method 500 may be adapted in various ways without departing from the scope of the present disclosure. For example, the preview generation and presentation steps 506 and 507 may be omitted in implementations where the operational mode permits direct editing with reduced mediation, as described with respect to the operational mode manager 115. The user confirmation step 508 may similarly be modified or omitted in certain operational modes. Additionally, while method 500 describes a single iterative loop between supervisory constraint notification at step 512 and preview regeneration at step 506, implementations may impose a maximum number of revision iterations after which the edit proposal is abandoned if supervisory validation cannot be achieved. The method 500 is not limited to any particular edit type and may be applied to any modification of the persistent cognitive manifold requiring governed execution and irreversible commitment.

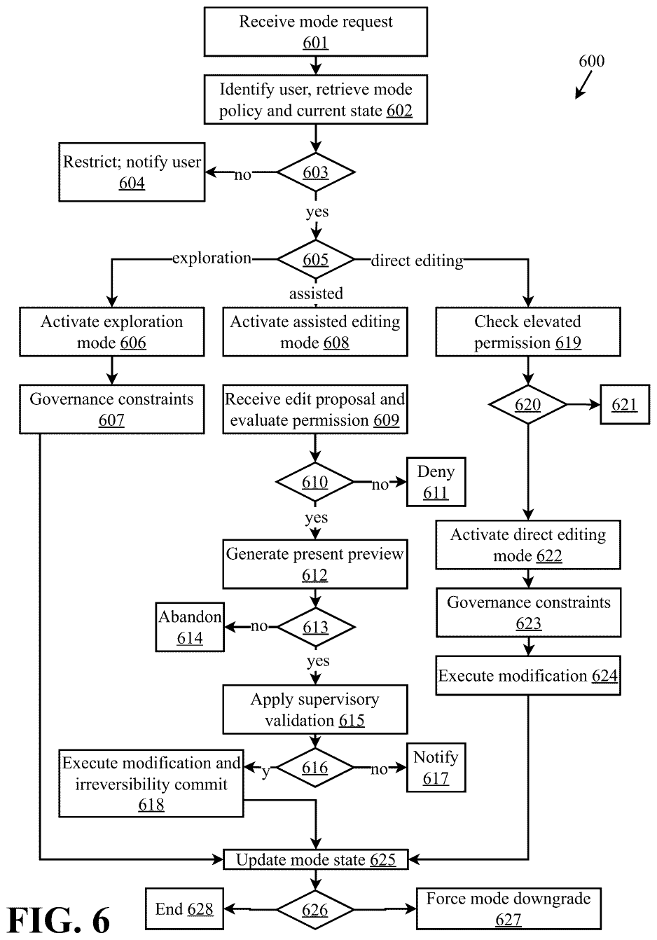

FIG. 6 is a flow diagram illustrating an exemplary method 600 for implementing operational mode selection and transition within the interactive geometric interface system, according to an embodiment. The method 600 describes a sequence of operations by which the system receives a request to operate in a particular mode, evaluates applicable governance policies, selects among the exploration, assisted editing, and direct editing modes, and executes the corresponding mode-specific processing pipeline subject to supervisory oversight and audit. The method 600 further describes how governance constraints differ across modes, what conditions trigger transitions between modes, and how the supervisory control layer may intervene to downgrade an active mode upon detection of instability or policy violation.

According to the embodiment, the process begins at step 601, at which operational mode manager 115 receives a mode request. A mode request may originate from a user interaction through the interactive geometric interface 110, from a supervisory policy directive, or from a system-level condition that requires a change in the interaction paradigm. The nature of the mode request is not limited to any particular form; any input interpretable as an instruction to establish, change, or re-evaluate the active operational mode constitutes a mode request for purposes of the present method.

At step 602, the system identifies the requesting user and retrieves the applicable mode policy and current mode state. User identification is accomplished through information maintained by user context manager 116, which supplies the requesting user's permissions, interaction history, and current system state. The applicable governance policies are retrieved from control layer 111 and supervisory control layer 114. The retrieved policies specify the conditions under which each operational mode is accessible to the requesting user, the access level associated with each mode, and any constraints that apply to mode-specific operations.

At decision point 603, the method determines whether the supervisory constraints applicable to the requested mode transition are satisfied. The supervisory control layer 114 evaluates the proposed transition against system-level constraints including permissible regions of the cognitive manifold, maximum rates of modification, irreversible commitment thresholds, and user-specific permissions. If the supervisory constraints are not satisfied, the method proceeds to step 604, at which the mode transition is restricted, the requesting user is notified of the constraint, and a denial event is recorded by auditability infrastructure 131. The method thereafter returns to step 601 to await a subsequent mode request. If the supervisory constraints are satisfied, the method proceeds to decision point 605.

At decision point 605, operational mode manager 115 determines which mode is requested. Where no prior mode has been established for the requesting user, such as during an initial interaction session, the system defaults to exploration mode in accordance with the applicable policy. The three branches emanating from decision point 605 correspond respectively to the exploration mode, the assisted editing mode, and the direct editing mode, each of which is described in the following paragraphs. The processing paths for each mode are executed in parallel columns, converging at step 625 after mode-specific operations are complete.

If the exploration mode branch is selected at step 605, the method proceeds to step 606, at which exploration mode is activated. In exploration mode, user interaction is limited to traversal and inspection of the cognitive manifold 100. User actions correspond to navigation among accessible regions, adjustment of viewpoints or focus, and selection of subsets of internal representations for display or use. Editing operations are disabled or deferred, and the persistent internal state remains unchanged. Exploration mode supports transparency, understanding, and discovery without advancing structural time within the system.

At step 607, the system applies the governance constraints applicable to exploration mode. The rate limit enforcer 282 limits the frequency and depth of traversal operations initiated through the interface, preventing excessive or destabilizing exploration of the cognitive manifold. Traversal operations remain subject to accessibility validation by the accessibility validator 280, which ensures that navigation requests comply with accessibility policies maintained by control layer 111. Edit operations are blocked by operational mode manager 115 throughout the duration of exploration mode. Because no modifications to persistent internal state are executed in exploration mode, structural time is not advanced and no irreversible commitment events are generated.

If the assisted editing mode branch is selected at step 605, the method proceeds to step 608, at which assisted editing mode is activated. The mode transition is immediately logged to auditability infrastructure 131 and the requesting user is notified of the active mode. In assisted editing mode, user interaction may propose modifications to the cognitive manifold, but such modifications are subject to additional mediation by control layer 111 and supervisory control layer 114 prior to commitment.

At step 609, the system receives an edit proposal from the user through interactive geometric interface 110 and evaluates the associated permission request. The editing operations manager 112 classifies the edit type and identifies the target region of the proposed modification. The control layer 111 performs an accessibility check to determine whether the target region is computationally accessible under the current policies, and assesses whether the requesting user's hierarchical permission level is sufficient to authorize the proposed operation. At decision point 610, the method determines whether permission for the proposed edit has been granted. If permission is not granted, the method proceeds to step 611, at which a denial response is returned to the user and the denial event is recorded by auditability infrastructure 131. The method thereafter returns to step 609 to await a subsequent edit proposal. If permission is granted, the method proceeds to step 612.

At step 612, the system generates a preview of the proposed modification and presents it to the user. Preview generation is performed by the preview and simulation infrastructure 132 through a non-destructive simulation of the proposed edit upon a clone of the current manifold state, producing a representation of the anticipated post-modification structure without altering the persistent internal state. The preview captures structural changes, alterations to relationships among representations, and consequential effects upon neighboring regions. The interactive geometric interface 110 renders the preview as a comparison view accompanied by any applicable warnings regarding policy constraints, irreversibility, or potential effects upon adjacent manifold regions.

At decision point 613, the method determines whether the user confirms the intention to proceed with the proposed modification following review of the preview. If the user does not confirm, the method proceeds to step 614, at which the edit proposal is abandoned and a cancellation event is logged to auditability infrastructure 131. If the user confirms the intention to proceed, the method advances to step 615.

At step 615, the system applies supervisory validation to the confirmed edit proposal. The supervisory control layer 114 assesses the proposed modification against system-level constraints including stability requirements, coherence requirements, and magnitude limits specifying the maximum allowable structural change permitted within a given interval. At decision point 616, the method determines whether supervisory validation has passed. If validation has not passed, the method proceeds to step 617, at which the user is notified of the specific constraint or constraints that the proposed modification does not satisfy and is invited to revise the proposal. The method returns to step 612 to generate a revised preview. If supervisory validation has passed, the method proceeds to step 618.

At step 618, the system executes the proposed modification to the persistent cognitive manifold and irreversibly commits the resulting change through the irreversible commitment mechanism 113. Structural time is advanced to reflect the committed modification as a permanent event in the temporal history of the cognitive manifold. Trace information describing the prior state of the affected manifold region is archived, and a comprehensive audit record incorporating the edit type, target region, structural time marker, user identifier, and description of structural changes effected is submitted to the auditability infrastructure 131.

If the direct editing mode branch is selected at step 605, the method proceeds to step 619, at which the system performs an elevated permission check. Direct editing mode may be restricted to trusted users, specific regions of the cognitive manifold, or predefined classes of modification. Accordingly, the system verifies that the requesting user possesses the requisite trusted user status, that the target region falls within the set of regions permissible for direct editing, and that the proposed class of modification falls within the predefined set authorized for reduced-mediation commitment.

At decision point 620, the method determines whether elevated permission and explicit approval from the supervisory control layer 114 have been obtained. If either condition is not satisfied, the method proceeds to step 621, at which the request for direct editing mode is denied and the system falls back to assisted editing mode. The fallback transition is logged to the auditability infrastructure 131 and the user is notified that the operation will proceed under assisted editing mode governance. If both conditions are satisfied, the method proceeds to step 622.

At step 622, the system activates direct editing mode. The mode transition is immediately logged to the auditability infrastructure 131 and the requesting user is notified of the active mode. In direct editing mode, user-directed modifications may be committed to the persistent internal state with reduced mediation compared to assisted editing mode. The preview generation and user confirmation steps applicable in assisted editing mode may be omitted in direct editing mode in accordance with the applicable policy, subject to the governance constraints applied at step 623.

At step 623, the system applies the governance constraints applicable to direct editing mode. The rate limit enforcer 282 enforces rate control over editing operations, regulating the frequency of committed edits, the magnitude of structural change permitted within a given interval, and the number of representations affected by a single operation. Notwithstanding the reduced mediation applicable in this mode, the supervisory control layer 114 remains active throughout and continues to enforce system-level constraints. At step 624, the system executes the proposed modification and irreversibly commits the resulting change through the irreversible commitment mechanism 113. Structural time is advanced, trace information is archived, and a mandatory audit record is generated and submitted to the auditability infrastructure 131.

Following completion of the mode-specific processing path, the three branches converge at step 625. At step 625, the operational mode manager 115 records the active mode, the user context manager 116 updates the interaction state, and a mode transition event is logged to the auditability infrastructure 131. The logged record includes the user identifier, the prior mode, the newly activated mode, a timestamp, and any applicable structural time marker, enabling subsequent inspection and review of how the operational mode has evolved over the course of user interaction.

At decision point 626, the method determines whether the supervisory control layer 114 has detected conditions indicative of instability, inconsistency, or undesired behavior in the active mode. The supervisory control layer 114 monitors the evolution of the cognitive manifold over time and may intervene upon detecting such conditions. If a supervisory anomaly is detected, the method proceeds to step 627, at which a forced mode downgrade is executed. The system restricts accessibility, reduces the active mode to a less privileged interaction paradigm, and logs the intervention event to the auditability infrastructure 131. The method thereafter returns to step 625 to update the mode state and notify the user of the revised active mode. If no supervisory anomaly is detected, the method proceeds to the terminal step 628.

At step 628, the active mode is maintained and the system awaits the next event. It will be appreciated that the method 600 may be adapted in various ways without departing from the scope of the present disclosure. For example, additional mode types may be defined beyond the three described herein, mode transitions may be subject to confirmation thresholds beyond those described, or the order of governance constraint evaluation and permission checking may be varied depending on system configuration. The method 600 is not limited to any particular class of user interaction and may be invoked by any component requiring operational mode arbitration within the interactive geometric interface system.

### Hardware Architecture

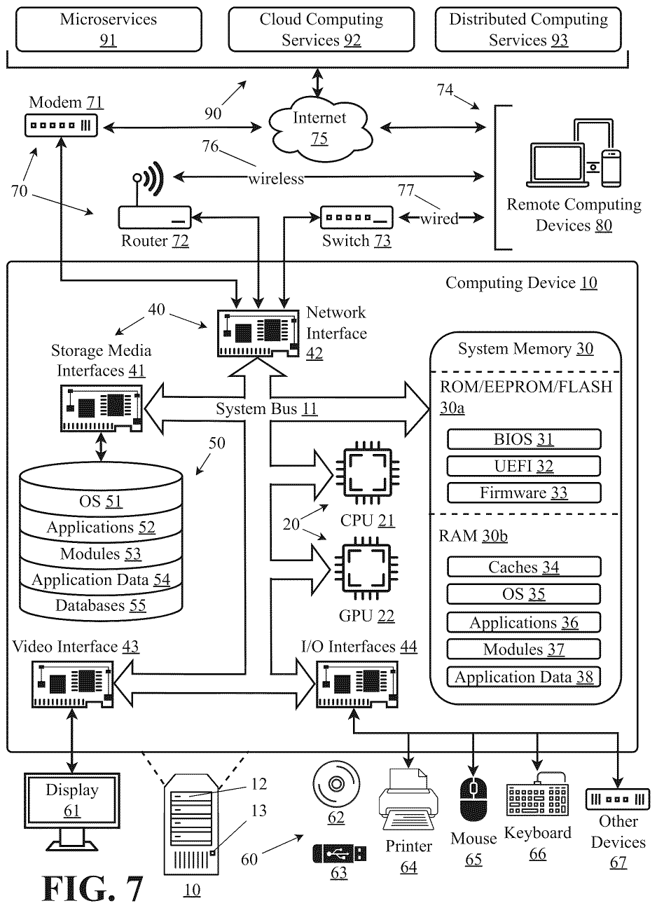

FIG. 7 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 13 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Container provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Federated distributed computing services 93 provide large-scale processing using multiple interconnected computers or nodes to solve computational problems or perform tasks collectively. In federated distributed computing, the processing and storage capabilities of multiple machines are leveraged to work together as a unified system, even when different tiers or tessellations may have limited or even no visibility into the resources and processing layer up or downstream. Federated distributed computing services are designed to address problems that cannot be efficiently solved by a single computer or that require large-scale computational power and require dynamism and workload distribution for economic, security or privacy reasons not well supported by canonical distributed computing resources; e.g. most commonly cloud-based computing applications, resources or analytics. Federated DCG coordinated variants of these services enable superior decentralization and further enhance parallel processing, fault tolerance, and scalability by distributing tasks across multiple tiers or tessellations while enabling computing process dependency calculation with varying degrees of visibility, assurance and privacy or security based on constituent computing system, network, workload and user or provider needs and preferences as well as practical legal and regulatory concerns to include but not limited to data localization, national data transfer restrictions, privacy and consumer protections, wiretap/telecommunications monitoring requirements, encryption and data routing and intermediate processing restrictions.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computing system for interactive engagement with a persistent cognitive manifold, comprising:
a processor; and
a memory storing instructions that, when executed by the processor, cause the computing system to:
maintain structured internal cognitive representations persistently across a plurality of user interactions;
receive user input corresponding to geometric interaction operations and interpret the user input as a request to traverse, inspect, or modify the structured internal representations;
enforce one or more accessibility policies governing which portions of the structured internal representations are computationally reachable by a requesting user during a given processing cycle;
select among a plurality of operational modes governing the manner in which user-directed modifications to the structured internal representations are mediated, validated, and committed; and
execute committed modifications irreversibly, such that prior states of affected representations are not restored following commitment.

2. The computing system of claim 1, wherein enforcing the one or more accessibility policies comprises distinguishing between representations that are stored within the system and representations that are operationally reachable or modifiable at a given time.

3. The computing system of claim 1, wherein selecting among the plurality of operational modes comprises defaulting to an exploration mode in which modification of persistent internal state is disabled, and transitioning to a mode permitting modifications in response to explicit user intent and satisfaction of applicable permission criteria.

4. The computing system of claim 1, wherein the instructions further cause the computing system to generate a preview of a proposed modification through non-destructive simulation prior to commitment, and to require user confirmation before executing the modification.

5. The computing system of claim 1, wherein executing committed modifications irreversibly comprises advancing a notion of structural time within the system upon each commitment, such that the system accumulates an ordered history of prior modification events without restoring accessibility to superseded representations.

6. The computing system of claim 1, wherein the instructions further cause the computing system to enforce rate control over user-directed modifications, limiting at least one of the frequency of committed modifications, the magnitude of structural change permitted within a given interval, and the number of representations affected by a single operation.

7. The computing system of claim 1, wherein the instructions further cause the computing system to monitor evolution of the structured internal representations over time and, upon detecting conditions indicative of instability or policy violation, restrict the active operational mode to a less privileged interaction paradigm.

8. The computing system of claim 1, wherein the instructions further cause the computing system to generate and maintain audit records associated with interaction and modification events, wherein the audit records comprise at least identifiers of affected representations, temporal markers, and user identifiers.

9. The computing system of claim 1, wherein the instructions further cause the computing system to support a plurality of users interacting with overlapping or partially shared structured internal representations, enforcing user-specific accessibility and modification permissions across the shared representations.

10. A computer-implemented method for interactive engagement with a persistent cognitive manifold, the method comprising the steps of:
maintaining structured internal cognitive representations persistently across a plurality of user interactions;
receiving user input corresponding to geometric interaction operations and interpreting the user input as a request to traverse, inspect, or modify the structured internal representations;
enforcing one or more accessibility policies governing which portions of the structured internal representations are computationally reachable by a requesting user during a given processing cycle;
selecting among a plurality of operational modes governing the manner in which user-directed modifications to the structured internal representations are mediated, validated, and committed; and
executing committed modifications irreversibly, such that prior states of affected representations are not restored following commitment.

11. The method of claim 10, wherein enforcing the one or more accessibility policies comprises distinguishing between representations that are stored within the system and representations that are operationally reachable or modifiable at a given time.

12. The method of claim 10, wherein selecting among the plurality of operational modes comprises defaulting to an exploration mode in which modification of persistent internal state is disabled, and transitioning to a mode permitting modifications in response to explicit user intent and satisfaction of applicable permission criteria.

13. The method of claim 10, further comprising generating a preview of a proposed modification through non-destructive simulation prior to commitment, and requiring user confirmation before executing the modification.

14. The method of claim 10, wherein executing committed modifications irreversibly comprises advancing a notion of structural time within the system upon each commitment, such that the system accumulates an ordered history of prior modification events without restoring accessibility to superseded representations.

15. The method of claim 10, further comprising enforcing rate control over user-directed modifications, limiting at least one of the frequency of committed modifications, the magnitude of structural change permitted within a given interval, and the number of representations affected by a single operation.

16. The method of claim 10, further comprising monitoring evolution of the structured internal representations over time and, upon detecting conditions indicative of instability or policy violation, restricting the active operational mode to a less privileged interaction paradigm.

17. The method of claim 10, further comprising generating and maintaining audit records associated with interaction and modification events, wherein the audit records comprise at least identifiers of affected representations, temporal markers, and user identifiers.

18. The method of claim 10, further comprising supporting a plurality of users interacting with overlapping or partially shared structured internal representations, and enforcing user-specific accessibility and modification permissions across the shared representations.
